(19) United States
(12) Patent Application Publication
(10) Pub. No.: US 2026/0336047 A1
(43) Pub. Date: Oct. 29, 2026

(54) INLAY JIG

(71) Applicant: Josue dos Santos Moraes, Batavia, IL (US)

(72) Inventor: Josue dos Santos Moraes, Batavia, IL (US)

(73) Assignee: BAM IP Holding LLC, Saint Charles, IL (US)

(21) Appl. No.: 19/188,850

(22) Filed: Apr. 24, 2025

(51) Int. Cl. B23Q 9/00; B27C 5/10

(52) U.S. Cl. CPC B23Q 9/0042; B27C 5/10

(57) ABSTRACT

A router inlay jig for holding templates is provided. The jig includes a base member, a rotation blocking member and a lock member. The base has a template receiving region. The blocking member is resiliently flexible between a first orientation and a second orientation. In the first orientation, the blocking member engages a template and inhibits angular rotation thereof. In a second orientation, the blocking member permits rotation of the template relative to the base. A lock member is movably mounted to the base member. The lock member is movable between a blocking position in which the lock member blocks the first rotation blocking member from transitioning from the first orientation to the second orientation and a released position in which the lock member does not block the first rotation blocking member from transitioning from the first orientation to the second orientation.

### FIELD OF THE INVENTION

This invention generally relates to woodworking jigs and particularly jigs for holding templates for use with routers.

### BACKGROUND OF THE INVENTION

Woodworkers will often add decorative features to a workpiece to include the aesthetic appearance of the workpiece. One particular technique to is to provide inlays within a workpiece. Typically, the inlay has a different aesthetic appearance than the surrounding material in which is located.

Typically, a recess is formed in the base material in the shape of the inlay and then a correspondingly shaped inlay is inserted into the recess. The user may manipulate the inlay such that it is coplanar with the surrounding material.

Often multiple inlays may be used in a single workpiece. The inlays may be used to form patterns. Templates have been used to help guide the user in making the various recesses at predetermined locations in the workpiece so as to improve the accuracy and aesthetic appeal of the resulting inlay. In some examples, the templates are used to guide a router for forming the recesses.

Prior systems have been difficult to adjust the position of the template or to replace the template with a different template as well as often wear reducing the accuracy of the resulting inlay design.

The present application provides improvements over the current state of the art as it relates to systems for assisting in forming recesses for use in inlays in a workpiece.

### BRIEF SUMMARY OF THE INVENTION

The application describes a new and improved inlay jig for use with a router. A new and improved base member is provided. New and improved templates are provided and new and improved locking features are provided.

In one example, an inlay jig includes a base member, a first rotation blocking member, and a lock member. The base member defines an inlay template receiving region having a generally circular circumferential boundary. The first rotation blocking member is resiliently flexible between a first orientation in which a first blocking detent of the first rotation blocking member is positioned within the circular circumferential boundary and a second orientation in which the blocking detent is positioned at or radially outward of the circular circumferential boundary. The lock member is movably mounted to the base member between a blocking position in which the lock member blocks the first rotation blocking member from transitioning from the first orientation to the second orientation and a released position in which the lock member does not block the first rotation blocking member from transitioning from the first orientation to the second orientation.

In one example, a second rotation blocking member is angularly spaced from the first rotation blocking member about a center of the circular circumferential boundary. The second rotation blocking member is resiliently flexible between a first orientation in which a second blocking detent of the second rotation blocking member is positioned within the circular circumferential boundary and a second orientation in which the second blocking detent is positioned at or radially outward of the circular circumferential boundary.

In one example, the first rotation blocking member has a cantilevered arm portion unitarily formed as a single piece with the base member.

In one example, the cantilevered arm portion extends in an angular configuration about a center of the circular circumferential boundary from a base portion to a distal free end.

In one example, the distal free end moves substantially in a radial direction when the first rotation blocking member transitions between the first and second orientations.

In one example, the blocking detent is separately formed from the cantilevered arm portion.

In one example, the blocking detent is a spherical member formed from a material having a lower coefficient of friction than the cantilevered arm portion.

In one example, the blocking detent has increased wear resistance over the cantilevered arm portion.

In one example, the lock member is caried in a cavity formed by the base member.

In one example, a third rotation blocking member is angularly spaced from the first and second rotation blocking members about the center of the circular circumferential boundary. The third rotation blocking member is resiliently flexible between a first orientation in which a third blocking detent of the third rotation blocking member is positioned within the circular circumferential boundary and a second orientation in which the third blocking detent is positioned at or radially outward of the circular circumferential boundary. The first, second and third blocking detents are equally angularly spaced apart about the center of the circular circumferential boundary.

In one example, the base includes a substantially circular boundary wall that defines, at least in part, the template receiving region. A first support shelf extends radially inward of the boundary wall. The first support shelf has a first support surface positioned between a router support surface of the base and an opposite workpiece abutment surface of the base. A second support shelf extends radially inward of the boundary wall. The second support shelf has a second support surface positioned between the router support surface of the base and the opposite workpiece abutment surface of the base. The second support shelf is angularly spaced from the first support shelf about a center of the circular circumferential boundary.

In one example, an inlay template is provided. The template has an outer periphery having a substantially circular shape. The outer periphery has a plurality of radially inward extending recesses including at least a first recess and a second recess. The first and second recesses are angularly spaced apart about a center defined by the outer periphery. The outer periphery is configured to correspond to the circular circumferential boundary of the template receiving region such that when located within the template receiving region, the inlay template can rotate relative to the base about the center defined by the outer periphery between a first position in which the first blocking detent extends into the first recess and a second position in which the second blocking detent extends into the first recess.

In one example, when the first blocking detent extends into the first recess or the second recess and the lock member is in the blocking position, the inlay template is prevented from rotating about the center of the outer periphery relative to the base.

In one example, when the first blocking detent extends into the first recess or the second recess and the lock member is in the released position, the inlay template is permitted to rotate relative to the base about the center of the outer periphery upon sufficient torque applied to the inlay template to cause the first blocking detent to resilient deflect out of the first recess or second recess.

In one example, the inlay template has a first router guide aperture extending therethrough. Positioning of the first router guide aperture relative to the first and second recesses is such that the first router guide aperture is positioned in a different orientation relative to the base when in the first position as compared to the second position.

In one example, an inlay template is provided. The inlay template has an outer periphery that has a substantially circular shape. The outer periphery has a plurality of radially inward extending recesses including at least a first recess and a second recess. The first and second recesses are angularly spaced apart about a center defined by the outer periphery. The outer periphery is configured to correspond to the circular circumferential boundary of the template receiving region such that when located within the template receiving region, the inlay template can rotate relative to the base about the center defined by the outer periphery between a first position in which the first blocking detent extends into the first recess and a second position in which the second blocking detent extends into the first recess. The inlay template has a second router support surface. When the inlay template is located within the template receiving region and is supported by the first and second support surfaces, the second router support surface is substantially complainer with the router support surface of the base.

In one example, the lock member does not extend outward beyond either the workpiece abutment surface or the router support surface.

In one example, the first and second recesses are V-shaped with the V-shape forming a mouth that opens in a radially outward extending direction.

In an example, an inlay jig including a base member, a first rotation blocking member and a template is provided. The base member holds the template. The base member defines an inlay template receiving region. The template receiving region permits angular rotation of a template mounted therein. A first rotation blocking member is resiliently flexible between a first orientation in which a first blocking detent of the first rotation blocking member is positioned within a circular circumferential boundary and a second orientation in which the blocking detent is positioned at or radially outward of the circular circumferential boundary. The template is carried within the template receiving region. The template has a plurality of recesses formed in an outer periphery thereof. The rotation blocking member engages a first one of the recesses in a first angular position and engages a second one of the recesses in a second angular position. When the rotation blocking member engages one of the plurality of recesses, rotation of the template relative to the base member is inhibited until a predetermined level of force is applied forcing the first rotation blocking member out of engage with the engaged recess.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of an inlay jig;

FIG. 2 is an exploded illustration of the inlay jig;

FIG. 3 is a cross-sectional illustration of the inlay jig showing the lock member in a released position;

FIG. 4 is a cross-sectional illustration of the inlay jig showing the lock member in a blocking position.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

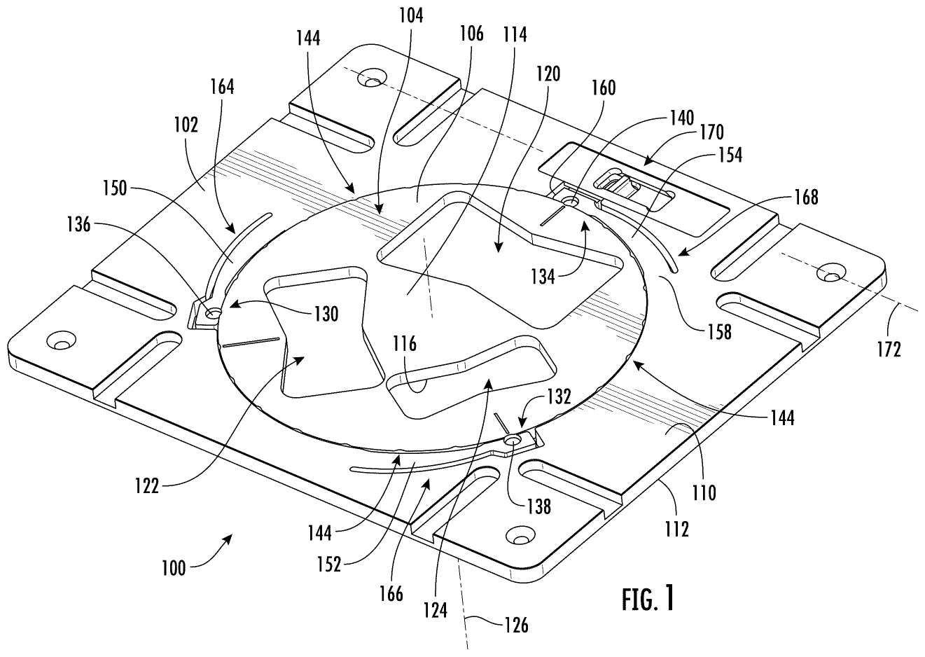

FIG. 1 illustrates an inlay jig 100 for use with a router for routing predefined depressions into a surface a workpiece for receipt of an inlay insert.

The inlay jig 100 includes a base member 102 that defines a template receiving region 104 configured to receive inlay templates 106 therein. While a single template is illustrated, templates having different patterns are contemplated.

In this example, the template receiving region 104 has a generally circular circumferential boundary defined by a substantially circular boundary wall 108. The boundary wall 108, generally extends between a first surface 110 and a second opposite surface 112.

In use, one of the first and second surfaces 110, 112 would be adjacent to and face the workpiece while the router would be adjacent to and face the other one of the first and second surfaces 110, 112. Typically, the first and second surfaces 110, 112 would be co-planar with or slightly proud of corresponding first and second template surfaces 114, 116.

The generally circular boundary of the template receiving region 104 allows for rotation of the template 106 within the base member 102 and particularly the template receiving region 104 between various different angular orientations. As such, a user would be able to clamp the base member 102 to the workpiece and, if desired, rotate the template 106 to different angular orientations within the template receiving region 104.

For example, a user could rotate the template 106 to orient different ones of the patterns 120, 122, 124 (also referred to as router guide apertures) within the template 106 about central axis 126 that extends through a center of the template receiving region 104.

The inlay jig 100 includes a plurality of rotation blocking members 130, 132, 134 configured to rotationally orient the inlay template 106 relative to the base member 102. This allows a user to more accurately align the inlay template 106 with a workpiece.

Each blocking member 130, 132, 134 includes a blocking detent 136, 138, 140 configured to engage corresponding recesses 144 of an outer periphery of the inlay template 106. In this example, twenty-four recesses 144 are provided equally spaced about around a center of the inlay template 106. As such, adjacent recesses 144 are spaced 15 degrees apart about the center of the template.

The blocking detents 136, 138, 140 of the blocking members 130, 132, 134 are equally angularly spaced apart about center axis 126 at 120 degrees between adjacent blocking detents 136, 138, 140.

In this example, each blocking member 130, 132, 134 is configured to resiliently bias the corresponding blocking detents 136, 138, 140 radially into aligned ones of the recesses 144. Here, the blocking detents 136, 138, 140, thus, extend radially inward of a circular boundary that is generally defined by the outer periphery of the inlay template.

To permit rotation of the template 106, each blocking member 130, 132, 134 is radially flexible between a first orientation where the blocking detents 136, 138, 140 is positioned within the circular circumferential boundary and a second orientation in which the blocking detents are positioned at or radially outward of the circumferential boundary.

In this example, the each blocking member 130, 132, 134 flexes between these to different orientations.

To provide the flexibility, each blocking member 130, 132, 134 includes an arm portion 150, 152, 154. In this example, the arm portion 150, 152, 154 is a cantilevered arm that generally extends in an angular configuration about central axis 126 from a base portion 158 towards a distal free end 160. In this example, arm portions 150, 152, 154 are unitarily formed with the rest of the base member 102. A slot 164, 166, 168 is formed between the arm portions 150, 152, 154 and the correspondingly adjacent portions of the base member 102. Further, the slots 164, 166, 168 allow for radially outward motion of the arm portions 150, 152, 154.

While the blocking members 130, 132, 134 are illustrated as formed as continuous piece of material with the rest of base member 102, other examples may have separately formed arm members that are operably attached to base member 102. In such examples spring members may or may not be used to provide the radial biasing force generated due to bending forces of illustrated arm portions 150, 152, 154.

The angularly configured arm portions 150, 152, 154, in this example, are generally arcuately extending from base portion 158 to distal free end 160. However, other examples could have straight arms. Further, in this example, the arms 150, 152, 154 have a tapered region that get narrower, when moving from the base portion 158 towards free end 160. Again, this is not required in all examples.

In this example the blocking detents 136, 138, 140 are inserts mounted to arm portions 150, 152, 154. In a preferred example, the blocking detents 136, 138, 140 are spheres received in corresponding pockets formed proximate distal end 160.

In a preferred, but not required, example, the blocking detents 136, 138, 140 are formed from a different material than the arm portions 150, 152, 154. In one example, the material of the blocking detents 136, 138, 140 is more wear resistant than the material of the arm portions 150, 152, 154 to prevent wear of the blocking detents 136, 138, 140 due to rotating or installation of the inlay templates 106. In some examples, a low friction material may be used to form the blocking detents 136, 138, 140. In one example, the material of the blocking detents 136, 138, 140 could be harder than the material used for the arm portions 150, 152, 154.

In operation, the distal free end moves substantially in a radially oriented direction as it transitions between the first and second orientations, such as when the template 106 is rotated within receiving region 104. More particularly, as the template 106 rotates, the blocking detents 136, 138, 140 are pushed out of recesses 144 in the template 106 and against the radially outermost peripheral portions of the template 106 between adjacent recesses 144. Once the blocking detents 136, 138, 140 align with corresponding recesses when the template 106 is in a desired angular position, the resilient loading of the arm portions 150, 152, 154 biases the blocking detents 136, 138, 140 into the newly aligned recesses 144 to generally secure the template 106 in the new angular position.

To further inhibit rotation of the template 106 relative to base member 102, a lock member 170 is movably mounted to the base member 102. In this example, the lock member is movable between a blocking position in which the lock member blocks at least one of the blocking members 130, 132, 134 from transitioning from the first orientation to the second orientation and a released position in which the lock member 170 does not block the blocking member 130, 132, 134 from transitioning from the first orientation to the second orientation.

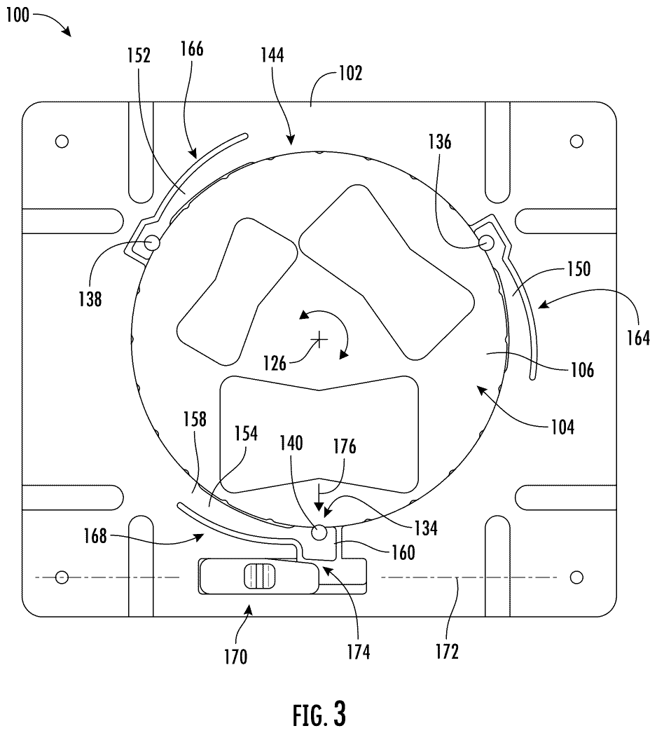

With reference to FIG. 3, the lock member is illustrated in the released position. In this position, the lock member 170 is slid to a position where the lock member 170 does not inhibit radial motion of the distal end 160 and the blocking detent 140 of blocking member 134. Here, a gap 174 is illustrated between lock member 170 and arm portion 154. This gap 174 is sufficient to permit radially outward displacement of the arm portion 154, as illustrated by arrow 176, to transition the blocking detent 140 outward of the circular boundary so that the template 106 may be rotated within the template receiving region 104.

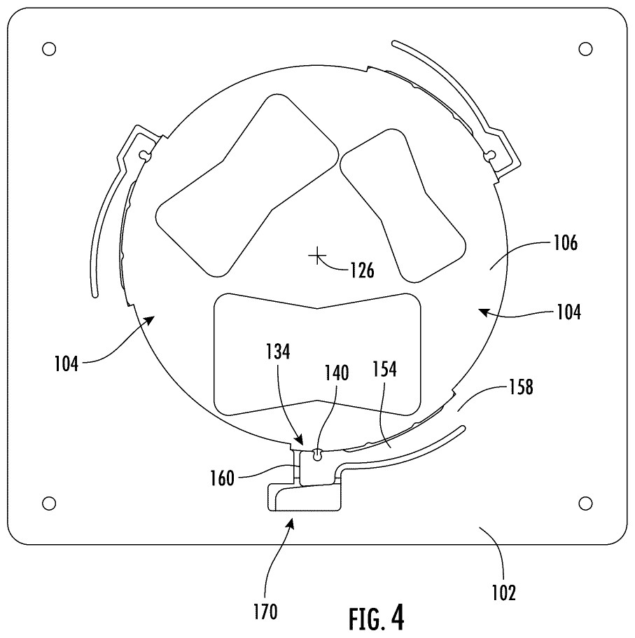

FIG. 4 illustrates the lock member 170 slid into the blocking position. Here, a radially inner surface of the lock member 170 abuts a radially outer surface of the blocking member 134. This prevents radially outward directed displacement of the end of the arm portion 154 to displace the blocking detent 140 out of recess 144 of the template 106. This maintains the blocking detent 140 in angular engagement with the template 106 preventing angular rotation of the template 106 relative to base member 102.

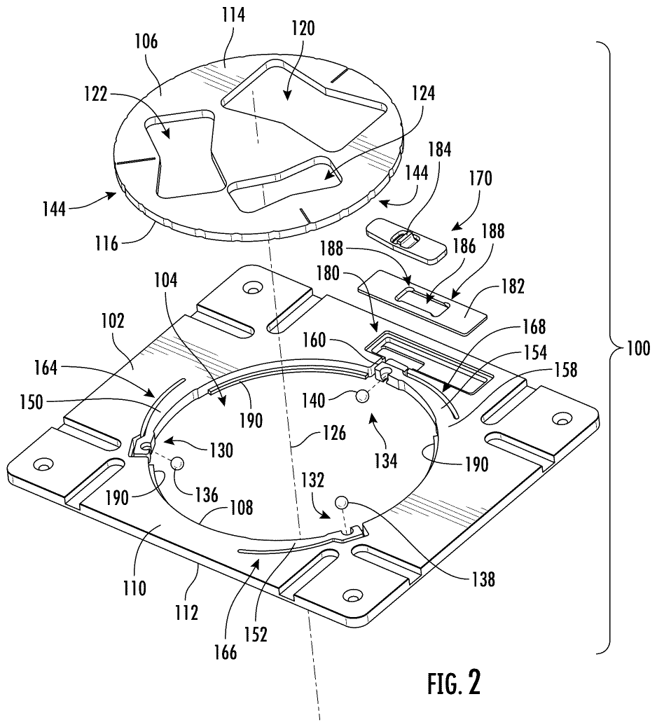

With reference to FIG. 2, in this example, the lock member 170 is slidably located within a recess 180 formed in base member 102. A cover 182 secures the lock member 170 in recess 180. The cover 182 includes an aperture 186 through which the user can engage the lock member 170 and, in a preferred example, a tab 184 thereof.

In a preferred example, the cover 182 and the lock member are at most flush with or recessed below first and second surfaces 110, 112 of base member 102 to prevent interference with the workpiece or a router, in use.

The cover may have catch regions, such as cut out regions 188, that engage portions of the lock member 170 to keep the lock member in the desired positions, e.g. released or blocking. These cut out regions 188 can engage tab 184, in this example, to prevent inadvertent movement. At a minimum, this could be provided to maintain the lock member 170 in the blocking position.

To position the templates 106 within the template receiving region 104, the base member has template support shelves 190. These template support shelves have support surfaces that are positioned between the first and second surfaces 110, 112 of the base member 102. The template 106 rests on these support shelves 190 and prevents the template 106 from being pushed entirely through the router receiving region 104. The shelves 190 extend radially inward from the boundary wall 108 defining, at least in part, the template receiving region 104.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A router inlay jig comprising:
a base member defining an inlay template receiving region, the template receiving region having a generally circular circumferential boundary;
a first rotation blocking member resiliently flexible between a first orientation in which a first blocking detent of the first rotation blocking member is positioned within the circular circumferential boundary and a second orientation in which the blocking detent is positioned at or radially outward of the circular circumferential boundary; and
a lock member movably mounted to the base member, the lock member movable between a blocking position in which the lock member blocks the first rotation blocking member from transitioning from the first orientation to the second orientation and a released position in which the lock member does not block the first rotation blocking member from transitioning from the first orientation to the second orientation.

2. The router inlay jig of claim 1, further including a second rotation blocking member angularly spaced from the first rotation blocking member about a center of the circular circumferential boundary, the second rotation blocking member resiliently flexible between a first orientation in which a second blocking detent of the second rotation blocking member is positioned within the circular circumferential boundary and a second orientation in which the second blocking detent is positioned at or radially outward of the circular circumferential boundary.

3. The router inlay jig of claim 1, wherein:
the first rotation blocking member has a cantilevered arm portion unitarily formed as a single piece with the base member.

4. The router inlay jig of claim 3, wherein the cantilevered arm portion extends in an angular configuration about a center of the circular circumferential boundary from a base portion to a distal free end.

5. The router inlay jig of claim 4, wherein the distal free end moves substantially in a radial direction when the first rotation blocking member transitions between the first and second orientations.

6. The router inlay jig of claim 3, wherein the blocking detent is separately formed from the cantilevered arm portion.

7. The router inlay jig of claim 6, wherein the blocking detent is a spherical member formed from a material having a lower coefficient of friction than the cantilevered arm portion.

8. The router inlay jig of claim 6, wherein the blocking detent has increased wear resistance over the cantilevered arm portion.

9. The router inlay jig of claim 1, wherein the lock member is caried in a cavity formed by the base member.

10. The router inlay jig of claim 2, further including a third rotation blocking member angularly spaced from the first and second rotation blocking members about the center of the circular circumferential boundary, the third rotation blocking member resiliently flexible between a first orientation in which a third blocking detent of the third rotation blocking member is positioned within the circular circumferential boundary and a second orientation in which the third blocking detent is positioned at or radially outward of the circular circumferential boundary, the first, second and third blocking detents being equally angularly spaced apart about the center of the circular circumferential boundary.

11. The router inlay jig of claim 1, wherein the base includes:
a substantially circular boundary wall that defines, at least in part, the template receiving region;
a first support shelf extending radially inward of the boundary wall, the first support shelf having a first support surface positioned between a router support surface of the base and an opposite workpiece abutment surface of the base; and
a second support shelf extending radially inward of the boundary wall, the second support shelf having a second support surface positioned between the router support surface of the base and the opposite workpiece abutment surface of the base, the second support shelf angularly spaced from the first support shelf about a center of the circular circumferential boundary.

12. The router inlay jig of claim 1, further including an inlay template, the inlay template having an outer periphery having a substantially circular shape, the outer periphery having a plurality of radially inward extending recesses including at least a first recess and a second recess, the first and second recesses being angularly spaced apart about a center defined by the outer periphery, the outer periphery configured to correspond to the circular circumferential boundary of the template receiving region such that when located within the template receiving region, the inlay template can rotate relative to the base about the center defined by the outer periphery between a first position in which the first blocking detent extends into the first recess and a second position in which the second blocking detent extends into the first recess.

13. The router inlay jig of claim 12, wherein when the first blocking detent extends into the first recess or the second recess and the lock member is in the blocking position, the inlay template is prevented from rotating about the center of the outer periphery relative to the base.

14. The router inlay jig of claim 13, wherein when the first blocking detent extends into the first recess or the second recess and the lock member is in the released position, the inlay template is permitted to rotate relative to the base about the center of the outer periphery upon sufficient torque applied to the inlay template to cause the first blocking detent to resilient deflect out of the first recess or second recess.

15. The router inlay jig of claim 12, wherein the inlay template has a first router guide aperture extending therethrough, the positioning of the first router guide aperture relative to the first and second recesses being such that the first router guide aperture is positioned in a different orientation relative to the base when in the first position as compared to the second position.

16. The router inlay jig of claim 11, further including an inlay template, the inlay template having an outer periphery having a substantially circular shape, the outer periphery having a plurality of radially inward extending recesses including at least a first recess and a second recess, the first and second recesses being angularly spaced apart about a center defined by the outer periphery, the outer periphery configured to correspond to the circular circumferential boundary of the template receiving region such that when located within the template receiving region, the inlay template can rotate relative to the base about the center defined by the outer periphery between a first position in which the first blocking detent extends into the first recess and a second position in which the second blocking detent extends into the first recess,
wherein:
the inlay template has a second router support surface;
when the inlay template is located within the template receiving region and is supported by the first and second support surfaces, the second router support surface is substantially complainer with the router support surface of the base.

17. The router inlay jig of claim 16, wherein the lock member does not extend outward beyond either the workpiece abutment surface or the router support surface.

18. The router inlay jig of claim 12, wherein the first and second recesses are V-shaped with the V-shape forming a mouth that opens in a radially outward extending direction.

19. A router inlay jig comprising:
a base member for holding a template, the base member defining an inlay template receiving region, the template receiving region permitting angular rotation of a template mounted therein; and
a first rotation blocking member resiliently flexible between a first orientation in which a first blocking detent of the first rotation blocking member is positioned within a circular circumferential boundary and a second orientation in which the blocking detent is positioned at or radially outward of the circular circumferential boundary;
a template carried within the template receiving region, the template having a plurality of recesses formed in an outer periphery thereof, the rotation blocking member engaging a first one of the recesses in a first angular position and engaging a second one of the recesses in a second angular position, when the rotation blocking member engages one of the plurality of recesses, rotation of the template relative to the base member is inhibited until a predetermined level of force is applied forcing the first rotation blocking member out of engage with the engaged recess.
